(19) United States
(12) Patent Application Publication
(10) Pub. No.: US 2003/0133775 A1
(43) Pub. Date: Jul. 17, 2003

(54) Device for the automatic removal of objects from containers

(76) Inventor: Hermann-Josef Spicher, Bergisch Gladbach (DE)

Correspondence Address: Steven J Grossman, Grossman Tucker Perreault & Pfleger, 55 South Commercial Street, Manchester, NH, 03101, US

(21) Appl. No.: 10/296,664

(22) PCT Filed: May 19, 2001
(86) PCT No.: PCT/DE01/01924

(30) Foreign Application Priority Data
May 26, 2000 (DE) 100 26 098.5

(51) Int. Cl. B66F 9/12

(52) U.S. Cl. 414/416.01

(57) ABSTRACT

The invention relates to a device for the automatic removal of objects from containers (4), by means of a movable removing arm (2), comprising a frame (1) to support the removing arm (1), a mounting (8), connected to the frame (1), with a gimbal mount for the removal arm (2), a drive mechanism for pivoting the removal arm (2), a device for the axial forwards and backwards displacement of the removal arm (2), a locating region (3) underneath the removal arm (2) for the placement of at least one container (4), which contains the objects for picking and a device for guiding the grab (27) on the removal arm (2) into various regions within the container (4). In order to improve the capacity of the device and to reduce the technical complexity thereof, the mounting (8), for the removal arm (2), is in the form of a swinging fork [symbol] ?(9), the axle of which is rotatably connected to the frame (1) and which may be driven by a separate motor (11). A support axle for the removal arm (2) is arranged on the fork legs, perpendicular to the rotating axis of the fork (9) and the removal arm (2) is rotatably mounted on the support axle, arranged on the swinging fork (9), by means of a swinging frame (16), whereby said swinging frame (16) may be driven by a separate motor.

The invention relates to an apparatus for the automatic individual or group-wise removal of objects from containers by means of a movable removal arm, comprising a frame for supporting the removal arm, a holder connected to the frame with a gimbal suspension for the removal arm, drives for pivoting the removal arm in various planes which are at an angle to each other, a device for axial forward and backward displacement of the removal arm, a receiving region beneath the removal arm for the placement of at least one container with the objects to be removed and a device for guiding the gripping portion of the removal arm to various regions in the interior of the container.

In a known apparatus of the specified kind (EP 0 143 897 B1) the frame which carries the holder for the removal arm comprises four corner pillars which are arranged in the four corners of the receiving region of the container and are connected to each other by way of transverse struts. The gimbal suspension comprises a horizontal, pivotably mounted support spindle which is supported in the upper region of the frame and on which the removal arm is suspended by way of a pivotable transverse spindle. The movement of the removal arm is effected by way of transverse spindles.

That known apparatus has greatly proven its worth. With the passage of time however it has become necessary to adapt the apparatus to meet new demands.

Therefore the object of the present invention is to enhance the performance of the apparatus and at the same time to reduce the technical complexity thereof.

In accordance with the invention that object is attained in that the holder for the removal arm is in the form of a pivotal fork, that the fork spindle is rotatably connected to the frame and is drivable by way of a separate motor, that arranged at the fork limbs is a support spindle for the removal arm, which extends perpendicularly to the pivot axis of the fork, and that the removal arm is rotatably mounted by means of a pivotal frame on the support spindle on the pivotal fork and is drivable by way of a separate motor.

In the apparatus according to the invention, the pivotal mechanism is of an extremely simple and effective nature from the structural point of view so that the movements in the individual planes can be performed more easily and more quickly.

In a preferred embodiment of the invention the pivotal fork is arranged horizontally and can be rotated about a horizontal pivot axis.

With such a structure, it is possible for the frame to be reduced to a minimum. It only needs to be arranged on one side of the container receiving region. That structure affords the advantage that the container receiving region is accessible from three sides.

If the container receiving region is to be provided only for a single container, the frame can be reduced to a single post to which the holder for the removal arm is fixed.

If in contrast the receiving region is intended for a plurality of containers which are arranged in a row in side-by-side relationship, the frame desirably has a horizontal support on which a carriage carrying the holder for the removal arm is displaceably guided. By means of the carriage, the removal arm can be moved alternately or successively to the individual containers.

In that respect the frame is desirably of a portal-like configuration with two posts which are arranged at a spacing from each other and between which the support is arranged.

In a particularly desirable embodiment of the invention the motor for driving the support spindle of the removal arm is arranged in the region of the gimbal suspension. That achieves a very compact structure which results in low mass moments of inertia and thus permits high levels of performance by means of relatively weak drives.

The device for axial forward and backward displacement of the removal arm is desirably in the form of a motor which is carried on the pivotal frame. That motor can drive a gear around which is passed a toothed belt fixed to the upper and lower ends of the removal arm.

That motor can also be arranged in the region of the gimbal suspension so that a further reduction in the mass moments of inertia is achieved thereby.

A free wheel is provided for the downwardly directed movement of the removal arm so that, when the removal arm moves downwardly, the removal arm can immediately stop upon encountering a resistance.

The invention is shown by way of example in the drawing and is described in detail hereinafter with reference to the drawing in which:

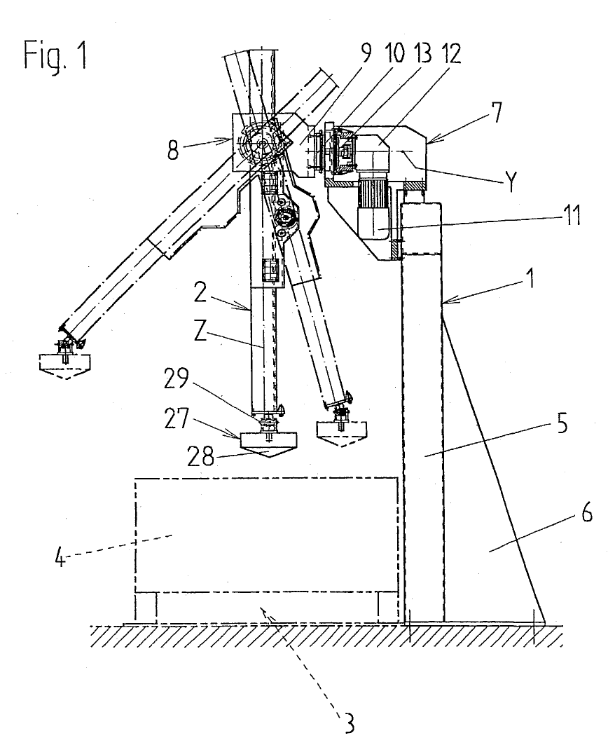

FIG. 1 shows a side view of a first embodiment of the invention,

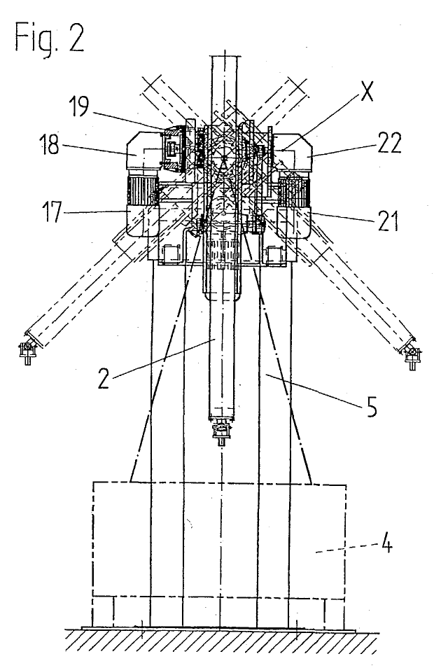

FIG. 2 shows a front view of the apparatus of FIG. 1,

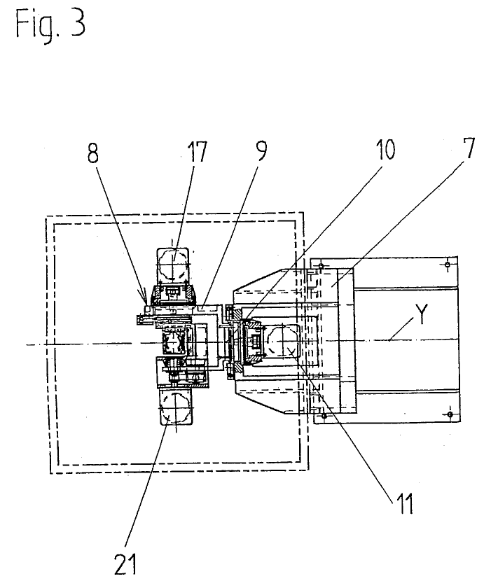

FIG. 3 shows a plan view of the apparatus of FIGS. 1 and 2,

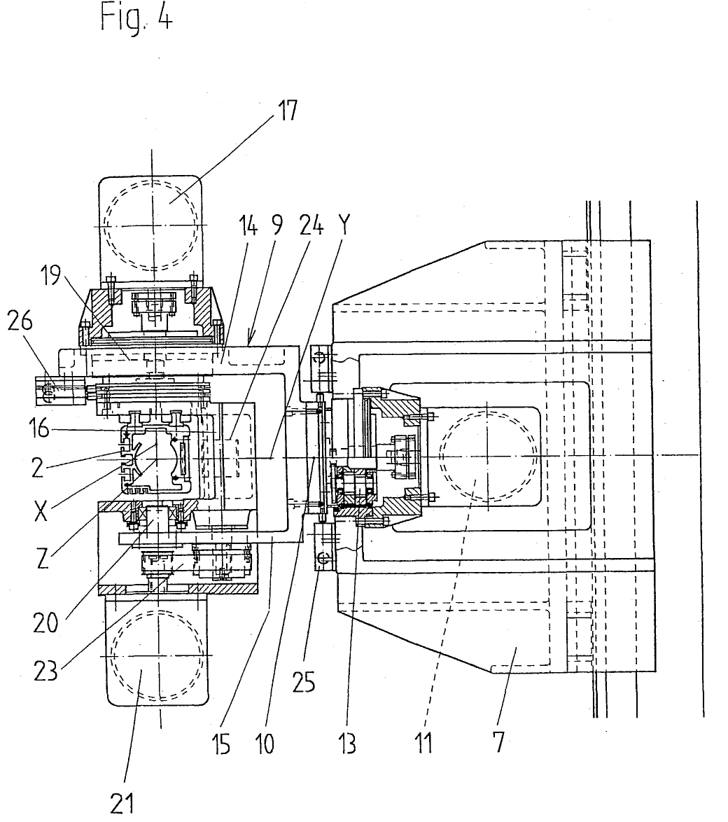

FIG. 4 shows a view on an enlarged scale illustrating the central region from FIG. 3,

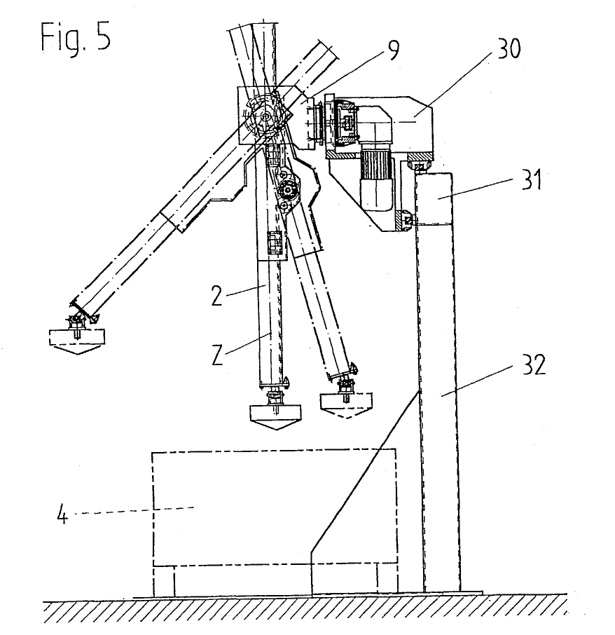

FIG. 5 shows a side view of a second embodiment of the invention,

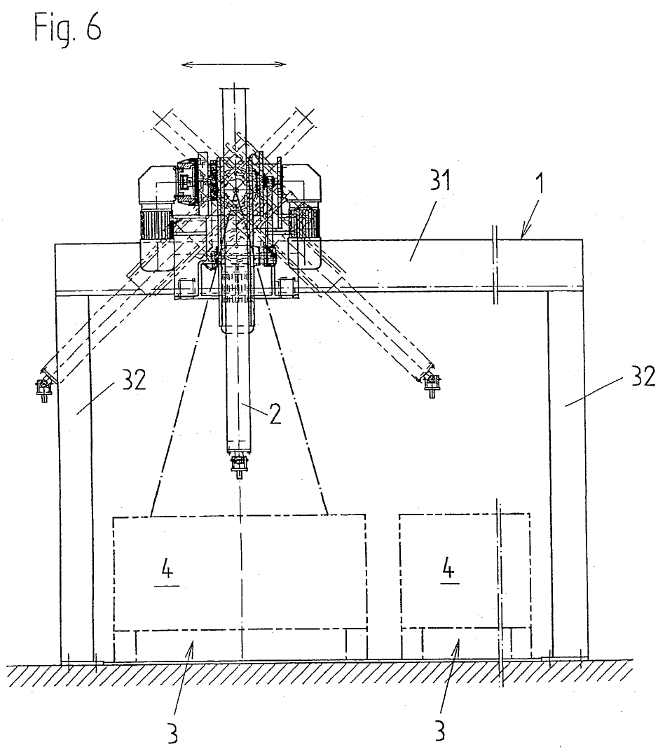

FIG. 6 shows a front view of the apparatus of FIG. 5, and

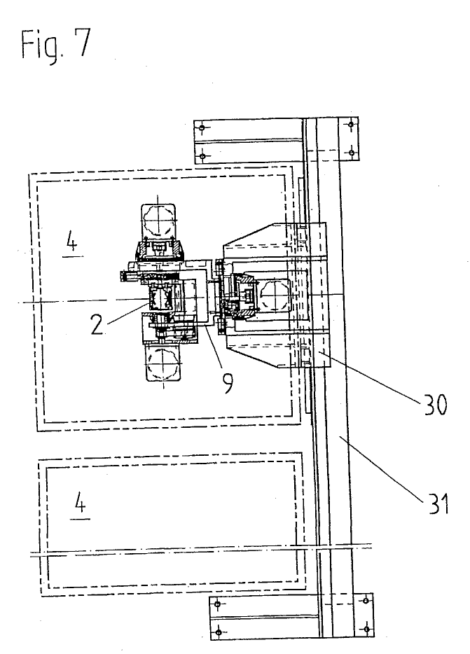

FIG. 7 shows a plan view of the apparatus of FIGS. 5 and 6.

As shown in the drawing the automatic removal apparatus substantially comprises a frame 1, a removal arm 2 suspended on the frame and a receiving region 3 provided beneath the removal arm 2 for a container 4 to be emptied.

In the embodiment illustrated in FIGS. 1-4 the frame 1 comprises a stationary post 5 which is fixedly anchored to the ground and which is stabilised with an additional lateral support 6 on its side remote from the container 4.

Carried at the upper end of the post 5 is a bracket 7 which is fixedly connected thereto and which carries the actual holder 8 for the removal arm 2.

As can be seen in particular from FIGS. 3 and 4, the holder 8 is in the form of a pivotal fork 9 whose spindle 10 is supported rotatably on the bracket 7. A motor 11 fixed to the bracket 7 serves to drive the fork spindle 10. The motor 11 is connected to the fork spindle 10 by way of an angle transmission 12 and a step-down transmission 13 with a high step-down ratio.

The fork spindle 10 is also referred to hereinafter as the Y-axis.

Disposed between the two legs 14 and 15 of the pivotal fork 9 is a pivotal frame 16 in which the removal arm 2 is longitudinally displaceably guided.

A motor 17 disposed directly on the fork limbs 14 serves to drive the pivotal frame 16. The pivotal frame 16 can be driven directly with the motor 17, with the interposition of an angle transmission 18 and a step-down transmission 19. The pivot axis of the pivotal frame 16 is referred to hereinafter as the X-axis.

The pivotal frame 16 is carried on the motor side directly on the output shaft of the step-down transmission 19 and is supported on the opposite side on a mounting trunnion 20 provided on the fork limb 15.

The removal arm 2 is longitudinally displaceably guided in the pivotal frame 16. The longitudinal axis is referred to hereinafter as the Z-axis.

A motor 21 serves to drive the removal arm 2 in the direction of the Z-axis. The motor 21 drives a gear 24 by way of an angle transmission 22 and a toothed belt step-down transmission. The gear 24 transmits the movement to the removal arm 2 in the direction of the Z-axis.

In the present case, the transmission medium is a toothed belt (not shown) which is fixed to the upper and lower ends of the removal arm 2 and is passed around the gear 24.

Alternatively the gear 24 could also co-operate with a rack provided on the removal arm.

While the motor 11 which serves to actuate the pivotal fork 9 about the Y-axis is fixedly carried on the bracket 7 the motor 17 which serves to pivot the pivotal frame 16 about the X-axis and the motor 21 which moves the removal arm 2 in the longitudinal direction, that is to say along the Z-axis, also perform the movements of the pivotal fork 9 therewith.

In order to keep down the moments of inertia the motors 17 and 21 which are also moved are arranged as closely as possible to the gimbal point. As can be seen in particular from FIGS. 2 through 4 the motors 17 and 21, with a horizontal basic position of the pivotal fork 9, are arranged vertically, that is to say the masses of those motors are very close to the fork 9 and thus to the gimbal point.

That very clever arrangement of the motors means that not only is the apparatus of a very compact configuration, but the mass moments of inertia are also kept very low so that, upon actuation, movements are possible at a high rate of acceleration or deceleration.

The end positions of all pivoting components are limited by limit switches 25 and 26.

In the direction of the longitudinal movement of the removal arm 2 a free wheel (not shown) provides for slip-free trailing movement of the removal arm in the downward direction. In the upward movement, the free wheel entrains the removal arm 2 in the direction of the Z-axis, in a slip-free manner.

Arranged at the lower end of the removal arm 2 is a gripping portion 27 which is adapted to the respective shape and property of the objects to be removed. In the embodiment illustrated in the drawing, the gripping portion 27 is in the form of a magnetic head 28 which is suspended at the lower end of the removal arm 2 by means of a universal joint 29. The magnetic head 28 therefore always faces perpendicularly downwardly.

The embodiment illustrated in FIGS. 5-7 is designed to empty a plurality of containers 4. The removal arm 2 is constructed in the same manner as in the first embodiment and the drives can also be of an identical configuration. Hereinafter the same references are used to denote corresponding components, as in the embodiment shown in FIGS. 1-4.

Just as in the case of the embodiment shown in FIGS. 1-4, the removal arm 2 is supported in a pivotal fork 9 which is fixed to a bracket. In contrast to the first-described embodiment however the bracket is not fixedly arranged on a post but is in the form of a travelling carriage 30 which is guided displaceably on a horizontal support 31. In this case the support 31 is fixed to two posts 32 arranged at a spacing from each other, thus forming a portal-like frame, in front of which two or more containers 4 can be placed in suitably provided container-receiving regions 3. The removal arm is then displaced to the individual containers 4 depending on the respectively prescribed unloading cycle.

With these described embodiments the corresponding structural configuration of the frame 1 permits the receiving region of the container to be accessible from three sides. An anti-ramming protective arrangement (not shown) serves as a shielding for the frame and the containers.

It will be appreciated that, when dealing with larger units, it is also possible for a plurality of removal arms to be simultaneously mounted on the support 31.

### List of References

1 frame

2 removal arm

3 receiving region

4 container

5 post

6 support

7 bracket

8 holder

9 pivotal fork

10 fork spindle

11 motor

12 angle transmission

13 step-down transmission

14 fork limb

15 fork limb

16 pivotal frame

17 motor (for pivotal frame)

18 angle transmission

19 step-down transmission

20 mounting trunnion

21 motor (for gear)

22 angle transmission

23 toothed belt step-down transmission

24 gear

25 limit switch

26 limit switch

27 gripping portion

28 magnetic head

29 universal joint

30 carriage

31 support

32 post

1. An apparatus for the automatic individual or group-wise removal of objects from containers (4) by means of a movable removal arm (2), comprising a frame (1) for supporting the removal arm (2), a holder (8) connected to the frame (1) with a gimbal suspension for the removal arm (2), drives for pivoting the removal arm (2) in various planes which are at an angle to each other, a device for axial forward and backward displacement of the removal arm (2), a receiving region (3) beneath the removal arm (2) for the placement of at least one container (4) with the objects to be removed and a device for guiding the gripping portion (27) of the removal arm (2) to various regions in the interior of the container (4), characterised in that the holder (8) for the removal arm (2) is in the form of a pivotal fork (9), that the fork spindle (10) is rotatably connected to the frame (1) and is drivable by way of a separate motor (11), that arranged at the fork limbs (14, 15) is a support spindle for the removal arm (2), which extends perpendicularly to the pivot axis of the fork (9), and that the removal arm (2) is rotatably mounted by means of a pivotal frame (16) on the support spindle on the pivotal fork (9) and the pivotal frame (16) is drivable by way of a separate motor (17).

2. Apparatus as set forth in claim 1 characterised in that the pivotal fork (9) is arranged horizontally.

3. Apparatus as set forth in claim 2 characterised in that the frame (1) is arranged on one side of the container-receiving region (3).

4. Apparatus as set forth in claim 2 or claim 3 characterised in that the frame is in the form of posts (5).

5. Apparatus as set forth in claim 2 or claim 3 characterised in that the frame has a horizontal support (31) on which a carriage (30) carrying the holder for the removal arm (2) is displaceably guided.

6. Apparatus as set forth in claim 5 characterised in that the frame is of a portal-like structure with two posts (32) which are arranged at a spacing from each other and between which the support (31) is arranged.

7. Apparatus as set forth in one of claims 1 through 6 characterised in that the motor (17) for driving the support spindle of the removal arm (2) is arranged in the region of the gimbal suspension.

8. Apparatus as set forth in one of claims 1 through 7 characterised in that the device for the axial forward and backward displacement of the removal arm (2) is in the form of a motor (21) carried on the pivotal frame (16).

9. Apparatus as set forth in claim 8 characterised in that the motor (21) drives a gear (24) around which is passed a toothed belt fixed to the upper and lower ends of the removal arm (2).

10. Apparatus as set forth in claim 8 or claim 9 characterised in that the motor (21) is arranged in the region of the gimbal suspension.

11. Apparatus as set forth in one of claims 8 through 10 characterised in that there is provided a free wheel for the downwardly directed movement of the removal arm (2).
